(19) United States
(12) Patent Application Publication
(10) Pub. No.: US 2020/0350657 A1
(43) Pub. Date: Nov. 5, 2020

(54) Symmetrical RFID Transponder Antenna

(71) Applicant: STAR Systems International Ltd., Kwai Chung (HK)

(72) Inventor: Chi Lun Mak, Kwai Chung (HK)

(21) Appl. No.: 16/400,457

(22) Filed: May 1, 2019

(51) Int. Cl. H01Q 1/22; G06K 19/077; H01Q 7/00

(52) U.S. Cl. CPC H01Q 1/2208; H01Q 7/00; G06K 19/07777

(57) ABSTRACT

An antenna for a Radio Frequency Identification (RFID) transponder, including: terminals for connection with an RFID chip; two or more inductive loops; and one or more resonant structure; wherein the two or more inductive loops and the one or more resonant structure are arranged and configured such that the antenna has two or more lines of symmetry when viewed in a thickness direction of the antenna, and wherein the terminals are located within a centre portion of an overall structure of the antenna.

### TECHNICAL FIELD

The present invention relates to a Radio Frequency Identification (RFID) transponder antenna.

### BACKGROUND

RFID is a technique used to identify objects by means of electromagnetic waves or radio frequency. An object can be tagged with an electronic code responding label. An electronic code responding label comprises an antenna and an integrated circuit.

In practice, RFID provides a quick and affordable means to identify objects. Upon receiving a valid interrogating signal from an interrogating source, such as from an interrogating antenna of an RFID reader, the electronic code responding label responds according to its designed protocol. As the electronic code responding label has an identification code which relates to the object that the electronic code responding label is attached to, by communicating with the electronic code responding label to retrieve the identification code representing the object, one can identify the presence of the object simply by identifying the presence of the electronic code responding label. An electronic code responding label sometimes is known as a label, tag, inlay, or a transponder, etc.

There are mainly two types of tags, active and passive. An active tag would have its own battery source, and has a greater read range than a passive RFID tag. However, an active tag is limited by the lifetime of its battery, and is more expensive and bulky than a passive tag. A passive tag, on the other hand, is a tag energised by an interrogating signal from an interrogating source (such as an RFID reader). It has a relatively shorter read range but has the advantage of cheaper price, smaller form factor, and the convenience of not needing replacement (due to the battery life) as compared with an active tag. It is vital that the antenna of a passive tag is designed well so that the interrogating signal can be received optimally to energise the chip of the passive tag. When the chip of the passive tag is powered, the antenna is used by the chip to transmit a signal back to the RFID reader. With this back and forth wireless communication, a communication link is setup successfully between the RFID reader and the passive tag. A common and simple form of a passive RFID tag is a one-piece structure of inlay i.e. the transponder is a single-layered design realized on plastic material. A common passive RFID tag antenna design comprises a single loop with two arms extended outward, retaining a one-piece single-layered structure with the RFID chip attached to the loop. Conventionally, the RFID tag antenna design is usually a mirrored image design with only one line-of-symmetry, with the chip located in the middle. However, some designs in the market do not even have a line of symmetry.

If the antenna design is not symmetrical, the radiation pattern is not symmetrical at all. Ideally, a dipole antenna is a symmetrical design and therefore it has a symmetrical radiation pattern of a donut-shape. Due to size requirements and limitations in real applications, a conventional RFID tag antenna has to be custom designed and has so deviated from the ideal dipole antenna design, usually with only one-line-of-symmetry, and therefore the radiation pattern is distorted from the donut-shaped pattern.

A non-symmetrical radiation pattern implies the beamwidth or gain along a particular direction is not equal to the opposite direction, which can be a problem for beamwidth-specific or gain-specific applications such as Automatic Vehicle Identification (AVI) etc. when the transponder has been accidentally placed incorrectly (e.g. upside down). In AVI, it is important to ensure an RFID tag of a vehicle, travelling within a certain lane, to be successfully read by a reader antenna that is covering the lane, and in the same time not being read by an adjacent reader antenna that is covering adjacent lanes. In other words, a transponder with symmetrical radiation patterns in multiple directions helps to avoid unwanted error when it is incorrectly placed.

The size of antenna design for an RFID tag depends on the operating frequency of the RFID tag. Common operating ranges includes LF band, HF band, UHF band, and microwave band. For the antenna design of this disclosure, it is designed for RFID tags operating within the UHF band. The global UHF RFID frequency band covers 860-960 MHz. For Europe, the ETSI band covers 865-868 MHz. In the US, the FCC band covers 902-928 MHz.

It is known that for designing a UHF transponder antenna, impedance matching between the antenna and the RFID chip is very important. This is to ensure that the power harvested by the antenna is transferred to the RFID chip to energise the RFID chip, and also to ensure the power from the chip can be transferred to the antenna effectively (backscattering). For optimal power transfer between the antenna and the RFID chip, the input impedance of the RFID chip should be the conjugate match of the impedance of the antenna. More specifically, if the input impedance of the RFID chip is R−jX ohm, which is frequency dependent, where R is the real part, and −X is the imaginary part of the chip's input impedance, the antenna input impedance conjugate matches the input impedance of the RFID chip when the antenna input impedance is R+jX ohm. When there is a conjugate match between the impedance of the RFID chip and the impedance of the RFID antenna, a maximum power transfer from each other can occur. Besides impedance matching, for the best read range performance, an antenna of an RFID tag has to be custom designed to ensure the antenna gains, radiation efficiency, radiation pattern, and polarization of the antenna is well-designed to fulfill some design considerations or constraints such as size requirement, material to be attached (or mounted), operating frequency band, etc.

Due to these design considerations and constraints, the RFID antenna is often designed to be a one-piece structure of inlay. For example, the antenna is a single layer antenna printed on a plastic film. Further, an RFID antenna is often designed to be directional in that it is more sensitive in a particular direction than others. The rationale is that a directional RFID antenna allows a better detection range in a particular direction.

The present disclosure presents an alternative antenna design for an RFID tag.

### SUMMARY

According to a first aspect of the present invention, there is provided an antenna for a Radio Frequency Identification (RFID) transponder, comprising: terminals for connection with an RFID chip; two or more inductive loops; and one or more resonant structure; wherein the two or more inductive loops and the one or more resonant structure are arranged and configured such that the antenna has two or more lines of symmetry when viewed in a thickness direction of the antenna, and wherein the terminals are located within a centre portion of an overall structure of the antenna.

In one form, the antenna comprises two inductive loops, each connected to a different resonant structure. In one form, the antenna comprises two inductive loops, each separated from, but capacitively coupled, to a different resonant structure. In one form, the one or more resonant structure comprises a fine-tuning portion. In one form, the antenna comprises two inductive loops, each connected to a same resonant structure. In one form, the radiation pattern of the antenna on a plane of the antenna, perpendicular to the thickness direction of the antenna, has two lines of symmetry.

According to another aspect of the present invention, there is provided a Radio Frequency Identification (RFID) transponder, comprising: an RFID chip; and an RFID antenna comprising: terminals for connection with an RFID chip; two or more inductive loops; and one or more resonant structure; wherein the two or more inductive loops and the one or more resonant structure are arranged and configured such that the antenna has two or more lines of symmetry when viewed in a thickness direction of the antenna, and wherein the terminals are located within a centre portion of an overall structure of the antenna.

### BRIEF DESCRIPTION OF DRAWINGS

Embodiments of the present invention will be discussed with reference to the accompanying drawings wherein:

FIG. 1 depicts one embodiment of the present disclosure;

FIG. 2 depicts the simulated 3D radiation pattern at 915 MHz of the RFID transponder antenna of FIG. 1 when the RFID transponder antenna of FIG. 1 is mounted on top of a 6 mm glass;

FIG. 3 depicts the corresponding simulated radiation pattern at theta of 90° (i.e. the XY plane) at 915 MHz of the antenna of FIG. 1;

FIG. 4 depicts the corresponding simulated power transfer coefficient (PCT) across the frequency band of the antenna of FIG. 1;

FIGS. 5 to 12 each depicts a different embodiment of the present disclosure;

FIGS. 13 and 14 show measurement results of prototypes of RFID tags mounted on glass with RFID transponder antennas based on the transponder antennas presented in this disclosure; and

FIGS. 15 and 16 show measurement results of prototypes of RFID tags mounted on a vehicle headlamp with RFID transponder antennas based on the transponder antennas presented in this disclosure.

FIGS. 17 and 18 show other forms of different embodiments.

### DESCRIPTION OF EMBODIMENTS

The present disclosure introduces a novel and inventive antenna design for RFID tags. In particular, the antenna is designed to have two or more lines of symmetry when viewed in a thickness direction of the antenna.

In a broad form, the antenna comprises terminals for connection with an RFID chip, two or more inductive loops, and one or more resonant structure. The two or more inductive loops and the one or more resonant structure are arranged and configured such that the antenna has two or more lines of symmetry when viewed in a thickness direction of the antenna. Further, the terminals are located within a centre portion of an overall structure of the antenna.

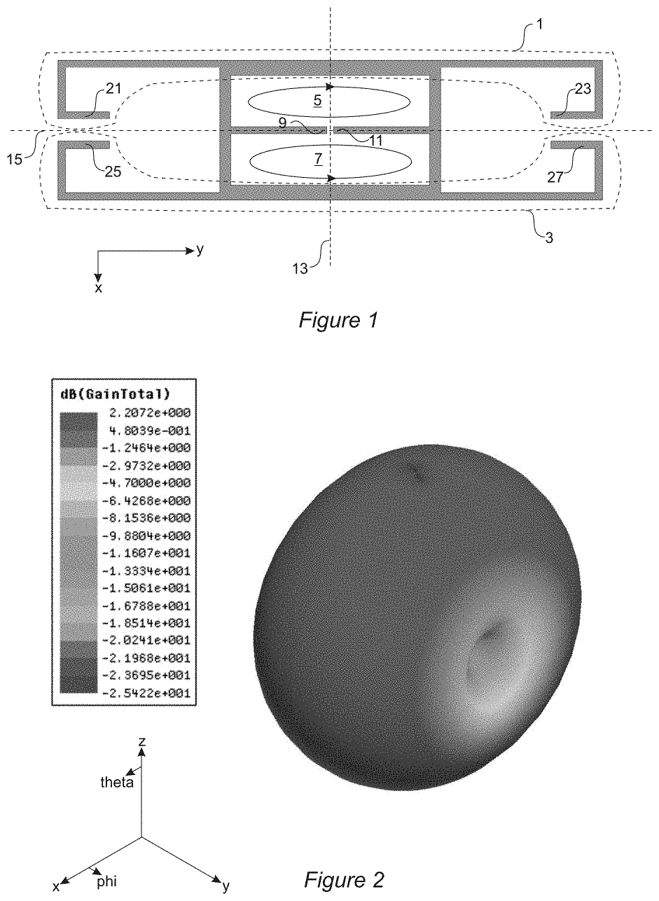

The phrase “lines of symmetry when viewed in a thickness direction” means when viewing in a thickness direction (same meaning as when viewed from a thickness direction) of an antenna (i.e. viewed from the top such as the view of FIG. 1), one can use a line to divide the antenna into two mirrored halves. Some antennas have zero line of symmetry, some have more than one. For example, a rectangular shape antenna has two lines of symmetry when viewed in a thickness direction. A square shape antenna has four lines of symmetry when viewed in a thickness direction. A circular shape antenna has infinite lines of symmetry when viewed in a thickness direction.

However, due to the design considerations and constraints, it was noted that conventional design of RFID tags focuses on maximising the read distance or attempting to impedance match an RFID chip with the antenna, to maximise power transfer and again to maximise read distance. To achieve that, the antenna is designed with only one line of symmetry. For example, a common UHF RFID antenna for a UHF RFID tag is usually a mirrored design with only one line of symmetry. The chip is usually connected to the antenna at the bottom middle section or top middle section depending on the reference direction and connected to a loop, where two mirrored arms extend from the loop to form a symmetrical design with one line of symmetry. This conventional idea is derived from a conventional dipole-type antenna, which has two opposite straight arms extended outward. A conventional dipole antenna provides a linearly polarized radiation pattern and with symmetrical donut-shaped radiation patterns.

Radiation pattern refers to the directional (angular) dependence of the strength of the radio waves from the antenna or from another source to the antenna. Due to the principle of reciprocity in antenna theory, the strength of radio waves at a direction from and to an antenna is the same. A directional radiation pattern simply means that there is a direction with a strength much stronger than those of the other directions. A directional radiation pattern is different from a uniform radiation pattern where the strength is the same in all directions (i.e. the Omni-directional radiation pattern with antenna gain of 0 dBi).

However, in practice, both left and right arms of the antenna have to be custom designed to accommodate some design constraints and requirements, such as size. Methods include meandering the arms, bending the ends to make hook-shaped ends, etc. Accordingly, it was found that based on the conventional design of an RFID tag, such as a UHF RFID tag, an RFID tag would only have a single line of symmetry with an RFID chip connected to the antenna at the bottom middle section or top middle section.

When a custom design deviated from a conventional dipole antenna to have only a single line of symmetry, the original donut-shaped radiation patterns become distorted. The radiation pattern is symmetrical along one direction only, but it is not symmetric in another directions. A non-symmetrical radiation pattern implies the beamwidth or gain along a particular direction is not equal to the opposite direction, which can be a problem for beamwidth-specific or gain-specific applications such as Automatic Vehicle Identification (AVI) etc. when the transponder has been accidentally placed incorrectly (e.g. upside down). In AVI, it is important to ensure an RFID tag mounted on a vehicle, travelling within a certain lane, to be successfully read by a reader antenna that is covering the lane, and at the same time not being read by an adjacent reader antenna that is covering adjacent lanes. In AVI, an RFID tag can be applied on a windshield, or headlamp. In other applications, such an RFID tag is applied on a label or sticker for inventory tracking, access control, etc. It finds its use in logistics and supply chain, as the movement of an item can be tracked automatically using an RFID system. A non-symmetrical radiation pattern may also create issues.

In the present disclosure, examples of antenna with two or more lines of symmetry when viewed in a thickness direction of the antenna are disclosed. Further, the terminals are located within a centre portion of an overall structure of the antenna. Such antennas have symmetrical radiation patterns in multiple directions, thus avoiding or reducing unwanted reading error when they are incorrectly misplaced.

With reference to FIG. 1, there is shown an exemplary antenna viewed in the thickness direction (Top view), i.e. the thickness of the antenna cannot be seen in FIG. 1, which has two lines of symmetry. The antenna has two inductive loops, indicated by loops 5 and 7. It has two resonant structures, indicated by 1 and 3. It has two terminals, 9 and 11, for connection with an RFID chip. As can be seen, FIG. 1 has two lines of symmetry, indicated by lines 13 and 15. The dimension of the RFID antenna can be adjusted such that the resonant frequency of the resonant structure and the inductive loop correspond to a design operating frequency of an RFID system, for example, 915 MHz, 900 MHz, or 875 MHz. As one particular example, the antenna is 74 mm in length (left to right) and 19 mm in height (top to bottom). Further, the antenna is provided with fine-tuning stubs (e.g. the hook-like ends), 21, 23, 25 and 27.

An inductive loop can take many forms, as long as the loop is inductive as opposed to capacitive. The term loop also does not necessitate the induction loop to be a single loop, or resemble a coil. In fact, it can be a square-loop, rectangular loop, multi-turn loop, or even with discontinuities, etc., as long as it is inductive. Being inductive does not mean that it contains no capacitance. A person skilled in the art would understand that capacitance exists in an inductive loop, but the degree of capacitance is lesser than its degree of inductance.

A resonant structure is a structure where, at a frequency of interest, the inductive impedance and capacitance impedance of circuit elements cancel each other. In relation to antenna design, resonant frequency is an important parameter. In simple form, a designer would want the resonant frequency of an antenna to be within the operating band (for UHF RFID antenna, it would be within the band of 860 MHz to 960 MHz). Depending on applications and regulations of some countries, the antenna can be specifically designed to resonate at a particular frequency. In other words, the resonant frequency of the resonant structure corresponds to a designed operating frequency of an RFID tag.

The inductive loop and the resonant structure can be made of the same material or different materials. In one form, they are made of copper or a dielectric material (such as a glass board, plastic sheet or a FR-4 PCB board). Of course they can be made with other conductive material deemed suitable by a person skilled in the art. The antenna can be made through various known manufacturing processes, such as printing, etching, milling etc. A complete RFID tag is then made by attaching a chip to an antenna. One common form is known as RFID inlay. It comprises a chip and aluminum, copper or silver antenna bonded to a polyethylene terephthalate (PET) layer that is delivered to the label maker “dry” (without adhesive) or “wet” (attached to a pressure sensitive liner). The inlay is adhered to the back side of the label and printed and encoded in an RFID printer.

The antenna of the present disclosure also shows that the inductive loop and the resonant structure are at a same plane. It should be understood that an antenna plane refers to a flat surface on which the majority of the antenna is located. It follows that the plane where the majority of the inductive loop is found, is the same plane where the majority of the resonant structure is found. In a broad sense, it does not require “all” parts of the inductive loop and the resonant structure to be at a same plane, just the “majority”.

An RFID chip is then connected to the antenna. In this disclosure, the RFID chip is connected to the inductive loop, and not connected to the resonant structure. When connected, and when the RFID tag (combination of the chip and an RFID antenna) is in operation in the presence of an RF field, current (AC current at that RF frequency) is induced and flows from the resonant structure to the inductive loop, which in turn induces an AC voltage at the RFID chip terminals, and power up the RFID chip, and continue to supply power to the RFID chip to allow the RFID chip to respond to an interrogating signal accordingly.

The resonant structure is connected to the inductive loop in the embodiment of FIG. 1. However, it is not necessarily so. The resonant structure can be capacitively coupled to the inductive loop, and separated physically and electrically from the inductive loop. If so, they should be close to each other (but not connected) to allow capacitive coupling. Such a capacitive coupling allows, the resonant structure to receive energy from the interrogating signal, then couples the received energy to the inductive coil, which then energises the RFID chip connected to the inductive coil.

It can also be seen from FIG. 1 that the RFID chip is connected to two terminals at the centre portion of the RFID antenna. Of course, in practice, the RFID chip may not be at the exact centre of the RFID antenna. It can be attached slightly off from the best position. However, as long as the terminals of the RFID chip are electrically connected to the terminals of the RFID antenna, the RFID would work. Theoretically, the connection of the RFID chip would not affect the performance of the RFID antenna.

Regarding the position of the terminals, the centre point of the terminals need not be exactly the centre point of the overall structure of the antenna. As long as the terminals are within a centre portion of an overall structure of the antenna, it would not affect in a substantial way the symmetry of the radiation pattern. For this disclosure, one can understand that the terminals are positioned within a centre region when the centre of the terminals is within a deviation from the centre of <5% of the length and <10% of the height of the RFID antenna. For example, with reference to 74 mm×19 mm, the deviation of the centre point of the terminals should not be more than 3.7 mm in the length direction and 1.9 mm in the height direction from the centre point of the overall structure of the RFID antenna.

Further, in one embodiment, the RFID chip is not directly connected to the terminals located at the centre portion of the RFID antenna. Whilst it is not ideal, it is possible to have the terminals connected to an RFID chip through a connecting means, such as a cable or a copper track. What is essential for the working of this disclosure is that the terminals are within a centre portion of an overall structure of the antenna, and having the overall radiating structure symmetrical in multiple planes/directions.

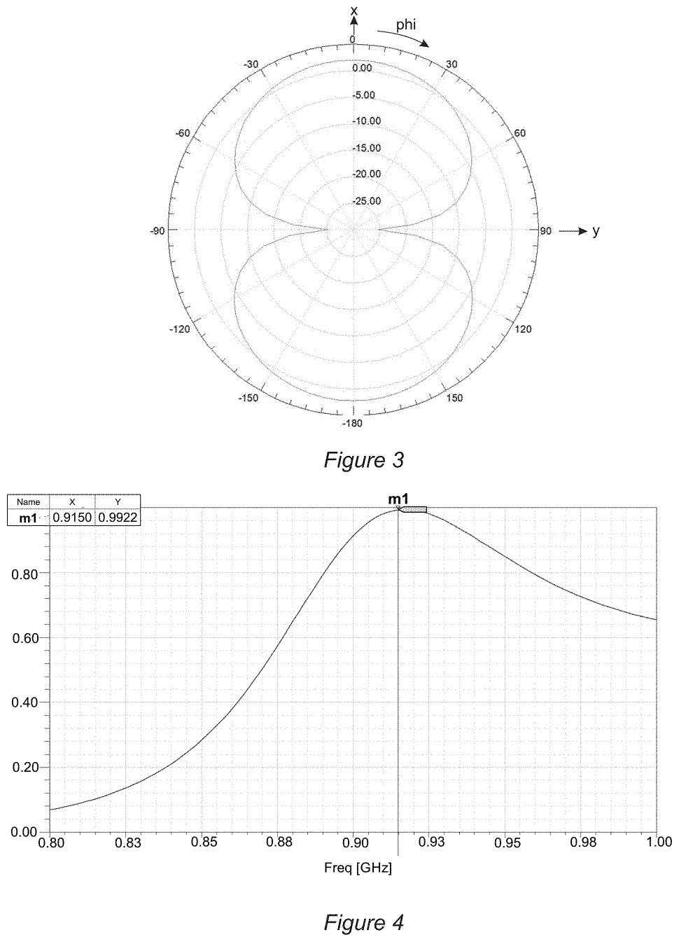

FIG. 2 depicts a corresponding radiation pattern of the RFID antenna of FIG. 1. As can be observed, the radiation pattern resembles a doughnut shape and is similar to the radiation pattern of a standard dipole antenna (resembles symmetrical features as standard dipole antenna). The antenna gain is around 2.2 dBi. This radiation pattern is not omni-directional (i.e. 0 dBi) in that the antenna performs better in a certain direction than the other. This is useful, as the maximum read distance of an RFID tag can be increased when the RFID tag is positioned correctly by having the most gain direction facing the transmit antenna of an RFID interrogator, and having both polarization of the transponder antenna and RFID interrogator antenna match. The difference between this radiation pattern as compared with a radiation pattern of a conventional RFID antenna is that the radiation pattern of a conventional antenna is only symmetrical in one plane as there is only one line of symmetry when viewed in the thickness direction. As the antenna of FIG. 1 has two lines of symmetry, there are two planes of symmetry (along x-axis and also along y-axis). As shown in FIG. 3, the radiation pattern of the antenna of FIG. 1 presents a symmetrical shape in two directions (i.e. up/down shapes with line-of-symmetry along y-axis—symmetry line 15; left/right shapes with line-of-symmetry along x-axis—symmetry line 13) in the x-y plane. While not shown, it can be seen from FIG. 2 that it also presents a symmetrical shape in both x-z plane and y-z plane (both with line-of-symmetry along z-axis).

FIG. 4 depicts simulation results of the RFID antenna of FIG. 1 when the RFID transponder antenna of FIG. 1 is mounted on top of a 6 mm glass of dielectric constant 5.5. The left axis represents “PTC” which stands for Power Transfer Coefficient. When perfect resonance occurs between the chip and antenna, PTC equals to 1. As it can be observed, the resonant frequency of the RFID antenna is at a frequency very near to 0.915 GHz, within the global RFID band of 860 to 960 MHz. The resonant frequency can be fine-tuned (moves up or down from the near resonant frequency of 0.915 GHz by adjusting the fine-tuning stubs, 21, 23, 25 and 27) to the desired frequency depending on the application of the RFID tag using the antenna of FIG. 1, and also depends on the country in which the RFID is being used as the band designated for RFID application may differ from country to country.

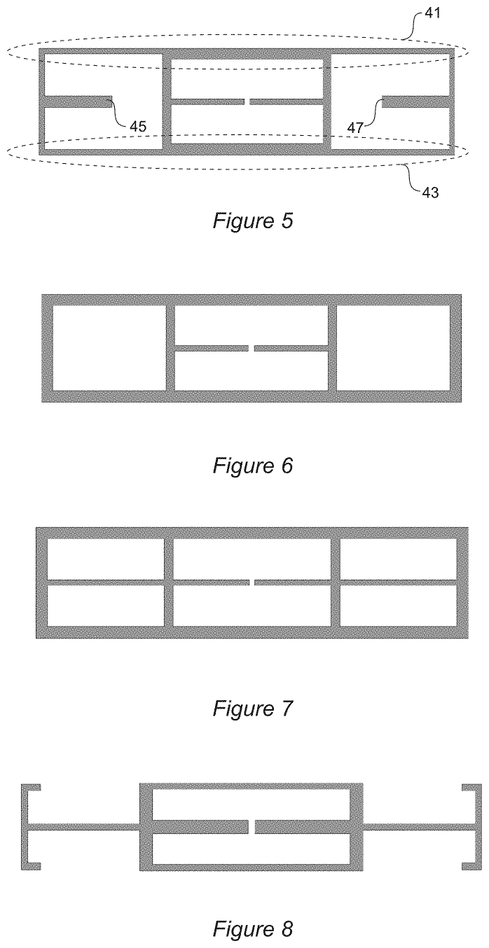

FIGS. 5 to 12 show more different embodiments of RFID antennas, each with two lines of symmetry when viewed in a thickness direction of the antenna, and wherein the terminals are located within a centre portion of an overall structure of the antenna.

With reference to FIG. 5, there are two inductive loops and two resonant structures. The two resonant structures 41 and 43 share the same fine-tuning stubs 45 and 47. The RFID chip is to be connected to the RFID antenna at terminals at the centre portion of the RFID antenna. There are two lines of symmetry.

With reference to FIGS. 6 and 7, each example depicts an antenna with two inductive loops and two resonant structures. The resonant structures have different lengths in the fine-tuning stubs 45 and 47, FIG. 6 has zero length and FIG. 7 has full length that is connected to the inductive loop. FIGS. 6 and 7 are based on FIG. 5. The RFID chip is to be connected to the RFID antenna at terminals at the centre portion of the RFID antenna. Each of them has two lines of symmetry.

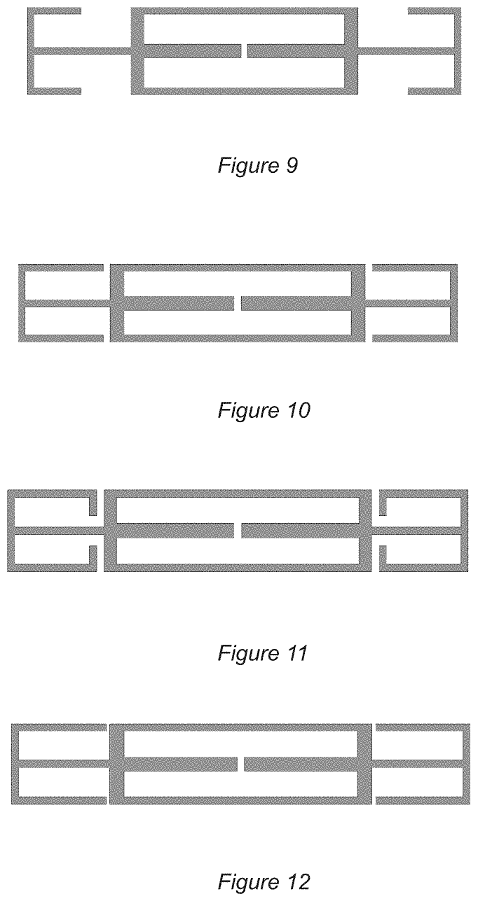

FIG. 8 depicts an example where there is only one resonant structure shared by two inductive loops. The RFID chip is to be connected to the RFID antenna at terminals at the centre portion of the RFID antenna. There are two lines of symmetry in FIG. 8. The antenna of FIG. 8 is measured at 70 mm×13 mm. The example of FIG. 9 is similar to the example of FIG. 8. There are two lines of symmetry in FIG. 9. It is measured at 65 mm×13 mm. Again, the dimensions can be changed to adhere to different design requirements. Fine tuning stubs are located at the end of the 4 hook-shaped structures.

FIGS. 10 to 12 show other design variations. Each of them has two lines of symmetry and has terminals for connecting to an RFID chip at the centre portion of the RFID antenna.

While the antenna of the present disclosure is designed to work for a passive tag, there is no reason why the designed antenna cannot be used in an active tag.

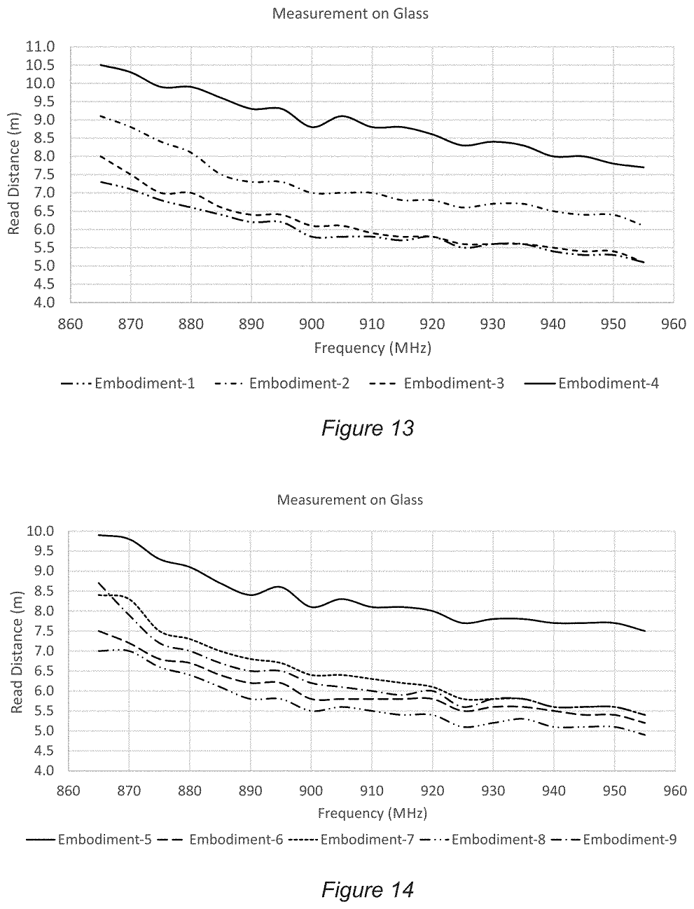

FIG. 13 shows measurement results of prototypes of RFID tags mounted on glass with RFID transponder antennas based on the antennas presented in this disclosure. In particular, Embodiment 1 referred to in FIG. 13 uses an antenna of FIG. 1, Embodiment 2 uses an antenna of FIG. 5, Embodiment 3 uses an antenna of FIG. 6, and Embodiment 4 uses an antenna of FIG. 7. As can be seen, the RFID tags perform relatively well at the 860 MHz end of the RFID band of 860 MHz to 960 MHz, with a read range of approximately 7.5 m to 10.5 m. In these results based on the above setup, Embodiment 4 offers the best read range.

Similar to FIG. 13, FIG. 14 shows measurement results of prototypes of RFID tags mounted on glass with RFID transponder antennas based on the antennas presented in this disclosure. In particular, Embodiment 5 referred to in FIG. 14 uses an antenna of FIG. 8, Embodiment 6 uses an antenna of FIG. 9, Embodiment 7 uses an antenna of FIG. 10, Embodiment 8 uses an antenna of FIG. 11, and Embodiment 9 uses an antenna of FIG. 12. As can be seen, the RFID tags perform relatively well at the 860 MHz end of the RFID band of 860 MHz to 960 MHz, with a read range of approximately 7 m to 10 m. In these results based on the above setup, Embodiment 5 offers the best read range.

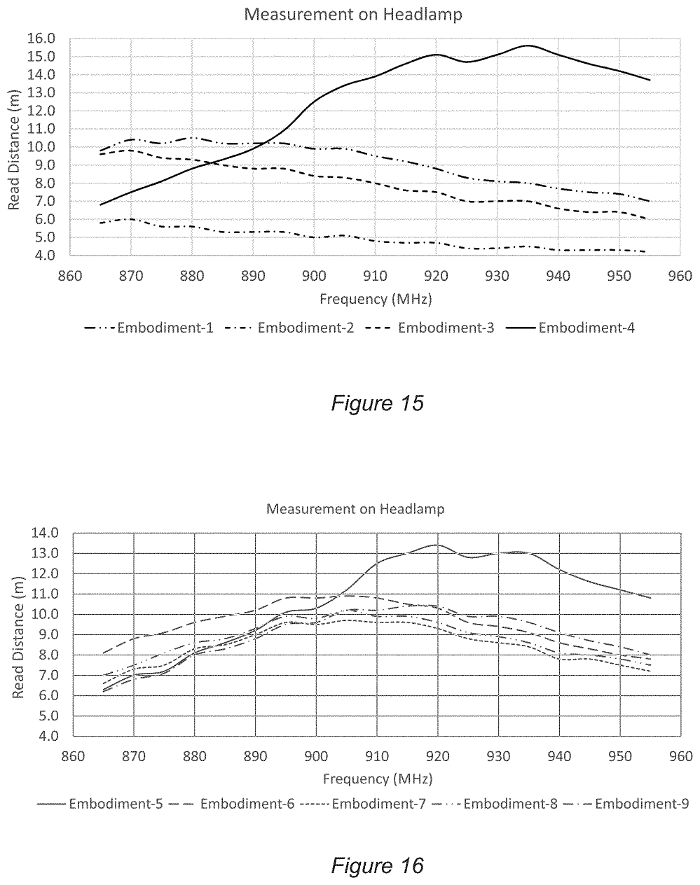

FIG. 15 shows measurement results of prototypes of RFID tags mounted on a vehicle headlamp with RFID transponder antennas based on the antennas presented in this disclosure. In particular, Embodiment 1 referred to in FIG. 13 uses an antenna of FIG. 1, Embodiment 2 uses an antenna of FIG. 5, Embodiment 3 uses an antenna of FIG. 6, and Embodiment 4 uses an antenna of FIG. 7. As can be seen, the RFID tags perform relatively well across the band of 860 MHz to 960 MHz. Embodiment 4 offers the best read range at almost 16 m at approximately 935 MHz.

FIG. 16 shows measurement results of prototypes of RFID tags mounted on a vehicle headlamp with RFID transponder antennas based on the antennas presented in this disclosure. In particular, Embodiment 5 referred to in FIG. 14 uses an antenna of FIG. 8, Embodiment 6 uses an antenna of FIG. 9, Embodiment 7 uses an antenna of FIG. 10, Embodiment 8 uses an antenna of FIG. 11, and Embodiment 9 uses an antenna of FIG. 12. As can be seen, the RFID tags perform relatively well across the band of 860 MHz to 960 MHz. Embodiment 5 offers the best read range at almost 13.5 m at approximately 920 MHz.

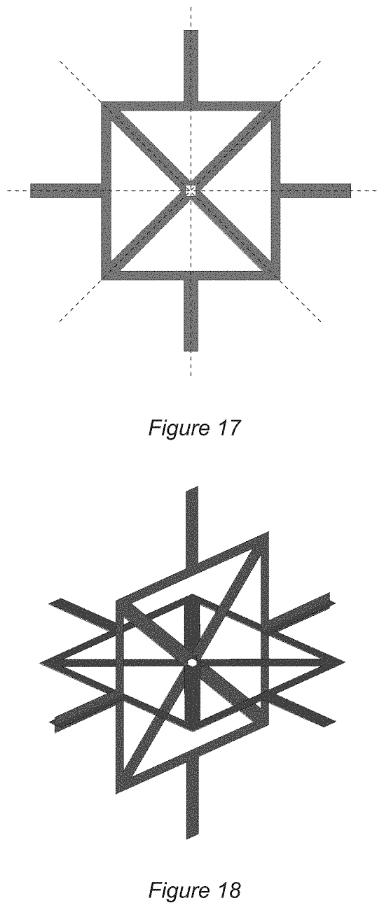

In one embodiment, it is possible to have more than two lines of symmetry. One example is shown in FIG. 17. In this example, there are four lines of symmetry. It is then possible to combine two or more of the antennas of FIG. 17, one perpendicular to the other to form a three-dimensional antenna, as shown in FIG. 18. It is expected that the radiation patterns will be symmetrical in multiple directions. When there are more lines of symmetry in a 3D structure, more “omni” is the radiation patterns.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement or any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. An antenna for a Radio Frequency Identification (RFID) transponder, comprising:
terminals for connection with an RFID chip;
two or more inductive loops; and
one or more resonant structure;
wherein the two or more inductive loops and the one or more resonant structure are arranged and configured such that the antenna has two or more lines of symmetry when viewed in a thickness direction of the antenna, and wherein the terminals are located within a centre portion of an overall structure of the antenna.

2. The antenna of claim 1, wherein the antenna comprises two inductive loops, each connected to a different resonant structure.

3. The antenna of claim 1, wherein the antenna comprises two inductive loops, each separated from, but capacitively coupled, to a different resonant structure.

4. The antenna of claim 1, wherein the one or more resonant structure comprises a fine-tuning portion.

5. The antenna of claim 1, wherein the antenna comprises two inductive loops, each connected to a same resonant structure.

6. The antenna of claim 1, wherein the radiation pattern of the antenna on a plane of the antenna, perpendicular to the thickness direction of the antenna, has two lines of symmetry.

7. A Radio Frequency Identification (RFID) transponder, comprising:
an RFID chip; and
an RFID antenna comprising:
terminals for connection with an RFID chip;
two or more inductive loops; and
one or more resonant structure;
wherein the two or more inductive loops and the one or more resonant structure are arranged and configured such that the antenna has two or more lines of symmetry when viewed in a thickness direction of the antenna, and wherein the terminals are located within a centre portion of an overall structure of the antenna.

8. The RFID transponder of claim 7, wherein the antenna comprises two inductive loops, each connected to a different resonant structure.

9. The RFID transponder of claim 7, wherein the antenna comprises two inductive loops, each separated from, but capacitively coupled, to a different resonant structure.

10. The RFID transponder of claim 7, wherein the one or more resonant structure comprises a fine-tuning portion.

11. The RFID transponder of claim 7, wherein the antenna comprises two inductive loops, each connected to a same resonant structure.

12. The RFID transponder of claim 7, wherein the radiation pattern of the antenna on a plane of the antenna, perpendicular to the thickness direction of the antenna, has two lines of symmetry.
